(19) United States
(12) Patent Application Publication
(10) Pub. No.: US 2025/0187699 A1
(43) Pub. Date: Jun. 12, 2025

(54) COMPONENT FOR HUMAN-POWERED VEHICLE AND ELECTRIC POWER SUPPLYING SYSTEM FOR HUMAN-POWERED VEHICLE

(71) Applicant: Shimano Inc., Osaka (JP)

(72) Inventor: Kazumasa MITSUNARI, Osaka (JP)

(21) Appl. No.: 18/535,872

(22) Filed: Dec. 11, 2023

(51) Int. Cl. B62M 6/45; B62J 45/20; B62M 6/55; B62M 6/90; B62M 9/122

(52) U.S. Cl. CPC B62M 6/45; B62J 45/20; B62M 6/55; B62M 6/90; B62M 9/122

(57) ABSTRACT

A component for a human-powered vehicle includes an electrical part, a notification device and a first controller. The electrical part is configured to be supplied with electric power from at least one of a first battery and an electric power supply source including a second battery. The first controller controls the notification device and issues a notification of first battery information related to a first battery level of the first battery in a case where the electrical part is supplied with electric power from the first battery and is not from the electric power supply source. The first controller controls the notification device and restricts notification of the first battery information and second battery information related to a second battery level of the second battery in a case where the electrical part is supplied with electric power from the electric power supply source.

### CROSS-REFERENCE TO RELATED APPLICATIONS

This application claims priority to Japanese Patent Application No. 2022-206726, filed on Dec. 23, 2023. The entire disclosure of Japanese Patent Application No. 2022-206726 is hereby incorporated herein by reference.

### BACKGROUND

### Technical Field

The present disclosure generally relates to a component for a human-powered vehicle and an electric power supplying system for a human-powered vehicle.

### Background Information

Japanese Laid-Open Patent Publication No. 2020-199878 discloses a human-powered vehicle that includes a battery configured to supply electric power to a component for the human-powered vehicle.

### SUMMARY

One objective of the present disclosure is to provide a component for a human-powered vehicle and an electric power supplying system for a human-powered vehicle that issue a notification of a battery level in a preferred manner.

A component in accordance with a first aspect of the present disclosure is for a human-powered vehicle. The component comprises an electrical part, a notification device and a first controller. The electrical part is configured to be supplied with electric power from at least one of a first battery and an electric power supply source including a second battery that differs from the first battery. The first controller is configured to control the notification device and issue a notification of first battery information related to a first battery level of the first battery in a case where the electrical part is supplied with electric power from the first battery and the electrical part is not supplied with electric power from the electric power supply source. The first controller is further configured to control the notification device and restrict notification of the first battery information and second battery information related to a second battery level of the second battery in a case where the electrical part is supplied with electric power from the electric power supply source.

In the component according to the first aspect, the first controller controls the notification device in accordance with the source of the electric power supplied to the electrical part. Thus, the component notifies the user of the battery level in a preferred manner. In a case where the electrical part is supplied with electric power from the first battery and is not supplied with electric power from the electric power supply source, a notification of the first battery information is issued. Thus, the first battery level is notified to the user in a preferred manner. The component allows the user to recognize the first battery level and thus improves usability.

A component in accordance with a second aspect of the present disclosure is for a human-powered vehicle. The component comprises an electrical part, a notification device and a first controller. The electrical part is configured to be supplied with electric power from at least one of a first battery and an electric power supply source including a second battery that differs from the first battery. The first controller is configured to control the notification device and issue a notification of first battery information related to a first battery level of the first battery in a case where the electrical part is supplied with electric power from the first battery. The first controller is configured to control the notification device and restrict notification of the first battery information and second battery information related to a second battery level of the second battery in a case where the electrical part is supplied with electric power from the electric power supply source and the electrical part is not supplied with electric power from the first battery.

In the component according to the second aspect, the first controller controls the notification device in accordance with the source of the electric power supplied to the electrical part. Thus, the component notifies the user of the battery level in a preferred manner. In a case where the electrical part is supplied with electric power from the first battery, a notification of the first battery information is issued. Thus, the first battery level is notified to the user in a preferred manner. The component allows the user to recognize the first battery level and thus improves usability.

In accordance with a third aspect of the present disclosure, the component according to the first or second aspect further comprises a user operating device configured to be operable by a user. The first controller is further configured to control the notification device and issue a notification of the first battery information in a case where the electrical part is not supplied with electric power from the electric power supply source and a predetermined operation is performed on the operating device in a state in which the electrical part is supplied with electric power from the first battery.

With the component according to the third aspect, the first controller controls the notification device and issues a notification of the first battery information in accordance with an operation of the operating device if the electrical part is not supplied with electric power from the electric power supply source in a state in which the electrical part is supplied with electric power from the first battery.

In accordance with a fourth aspect of the present disclosure, in the component according to the third aspect, the first controller is configured to control the notification device so as not to issue a notification of the first battery information and the second battery information in a case where the predetermined operation is performed on the operating device in a state in which the electrical part is supplied with electric power from the electric power supply source.

With the component according to the fourth aspect, the first controller controls the notification device so as not to issue a notification of the first battery information and the second battery information in accordance with an operation performed on the operating device in a state in which the electrical part is supplied with electric power from the electric power supply source.

In accordance with a fifth aspect of the present disclosure, the component according to the third or fourth aspect is configured so that the predetermined operation includes a first operation in which the operating device is operated over a predetermined time and a second operation in which the operating device is operated a number of times.

With the component according to the fifth aspect, the first controller controls the notification device in accordance with at least one of the first operation, in which the operating device is operated over a predetermined time, and the second operation, in which the operating device is operated a number of times.

In accordance with a sixth aspect of the present disclosure, in the component according to any one of the first to fifth aspects, the first controller is configured to control the notification device and issue a notification of the first battery information in a case where the electrical part is not supplied with electric power from the electric power supply source and the first battery level is less than or equal to a predetermined threshold value in a state in which the electrical part is supplied with electric power from the first battery.

With the component according to the sixth aspect, the first controller controls the notification device and issues a notification of the first battery information in accordance with the first battery level if the electrical part is not supplied with electric power from the electric power supply source in a state in which the electrical part is supplied with electric power from the first battery.

In accordance with a seventh aspect of the present disclosure, the component according to any one of the first to sixth aspects further comprises a battery mount allowing for attachment and detachment of the first battery.

The component according to the seventh aspect facilitates attachment and detachment of the first battery.

In accordance with an eighth aspect of the present disclosure, the component according to any one of the first to seventh aspects is configured so that the notification device includes a light-emitting portion.

With the component according to the eighth aspect, the light-emitting portion allows the user to visually recognize the first battery information.

In accordance with a ninth aspect of the present disclosure, the component according to any one of the first to eighth aspects further comprises a communication device that receives the second battery information.

With the component according to the ninth aspect, the second battery information is received from the second battery through the communication device.

In accordance with a tenth aspect of the present disclosure, the component according to any one of the first to ninth aspects is configured so that the component is a transmission device, an electric adjustable seatpost, an electric suspension, or a lamp.

With the component according to the tenth aspect, the first controller controls the notification device in accordance with a source that supplies electric power to the electrical part of the transmission device, the electric adjustable seatpost, the electric suspension, or the lamp.

In accordance with an eleventh aspect of the present disclosure, the component according to the tenth aspect is configured so that the component is the transmission device, and the transmission device includes a rear derailleur.

With the component according to the eleventh aspect, the first controller controls the notification device in accordance with a source that supplies electric power to the rear derailleur.

In accordance with a twelfth aspect of the present disclosure, the component according to any one of the first to eleventh aspects is configured so that in a case where electric power from both of the first battery and the electric power supply source is receivable by the component, the first controller is configured to select either one of a first state, in which the electrical part is supplied with electric power from the first battery and the electrical part is not supplied with electric power from the electric power supply source, and a second state, in which the electrical part is not supplied with electric power from the first battery and the electrical part is supplied with electric power from the electric power supply source.

With the component according to the twelfth aspect, in a case where the component is configured to receive electric power from both the first battery and the electric power supply source, the first controller can select one of the first state and the second state to change the source that supplies electric power in a preferred manner.

An electric power supplying system in accordance with a thirteenth aspect of the present disclosure is for a human-powered vehicle. The electric power supplying system comprises the component according to any one of the first to twelfth aspects, the first battery, and the second battery.

With the electric power supplying system according to the thirteenth aspect, the battery level is notified to the user in a preferred manner in accordance with the source that supplies electric power.

An electric power supplying system in accordance with a fourteenth aspect of the present disclosure is for a human-powered vehicle. The electric power supplying system comprises the component according to the first or second aspect and a relay device connected to both of the component and the electric power supply source in a manner allowing for communication.

With the electric power supplying system according to the fourteenth aspect, the component obtains information related to the electric power supply source via the relay device.

In accordance with a fifteenth aspect of the present disclosure, the electric power supplying system according to the fourteenth aspect is configured so that the relay device includes a first communication device that communicates with the component and a second communication device that communicates with the electric power supply source. The first communication device uses a communication protocol differing from that of the second communication device.

With the electric power supplying system according to the fifteenth aspect, the relay device allows the first communication device to communicate with the second communication device, which differs in communication protocol.

In accordance with a sixteenth aspect of the present disclosure, the electric power supplying system according to the fourteenth or fifteenth aspect is configured so that the relay device includes a second controller. The second controller is configured to control the first controller and restrict notification of the first battery information and the second battery information.

With the electric power supplying system according to the sixteenth aspect, the second controller controls the first controller so that the first controller restricts notification of the first battery information and the second battery information.

In accordance with a seventeenth aspect of the present disclosure, the electric power supplying system according to any one of the fourteenth to sixteenth aspects is configured so that electric power is supplied from the electric power supply source via the relay device to the electrical part.

With the electric power supplying system according to the seventeenth aspect, the component receives electric power from the electric power supply source via the relay device.

In accordance with an eighteenth aspect of the present disclosure, the electric power supplying system according to any one of the thirteenth to seventeenth aspects is configured so that the electric power supply source further includes a drive unit configured to apply a propulsion force to the human-powered vehicle. The second battery is configured to supply the electrical part with electric power via the drive unit.

With the electric power supplying system according to the eighteenth aspect, the component receives electric power from the second battery via the drive unit.

In accordance with a nineteenth aspect of the present disclosure, the electric power supplying system according to any one of the thirteenth to eighteenth aspects further comprises an operating device used to operate the component. The operating device sends an operation signal for operating the component via the electric power supply source to the component.

With the electric power supplying system according to the nineteenth aspect, the component receives an operation signal from the operating device via the drive unit.

The component for a human-powered vehicle and the electric power supplying system for a human-powered vehicle according to the present disclosure issue a notification of the battery level in a preferred manner.

### BRIEF DESCRIPTION OF THE DRAWINGS

Referring now to the attached drawings which form a part of this original disclosure, selected illustrative embodiments are shown.

FIG. 1 is a side elevational view of a human-powered vehicle including a component and an electric power supplying system in accordance with a first embodiment.

FIG. 2 is a block diagram showing the electrical configuration of the human-powered vehicle shown in FIG. 1, including the component and the electric power supplying system, in a case where an electrical part is supplied with electric power from a first battery.

FIG. 3 is a block diagram showing the electrical configuration of the human-powered vehicle shown in FIG. 1, including the component and the electric power supplying system, in a case where an electrical part is supplied with electric power from a second battery.

FIG. 4 is a flowchart of a process for controlling a notification unit executed by a first controller shown in FIGS. 2 and 3.

FIG. 5 is a flowchart of a process executed by a battery controller shown in FIG. 2.

FIG. 6 is a flowchart of a process executed by a second controller shown in FIG. 3.

FIG. 7 is a flowchart of a process for controlling a notification unit executed by a first controller in accordance with a second embodiment.

FIG. 8 is a flowchart of a process for controlling a notification unit executed by a first controller in accordance with a third embodiment.

FIG. 9 is a flowchart of a process for controlling a notification unit executed by a first controller in accordance with a fourth embodiment.

FIG. 10 is a block diagram showing the electrical configuration of a human-powered vehicle including a component for the human-powered vehicle and an electric power supplying system for the human-powered vehicle in accordance with a fifth embodiment.

FIG. 11 is a flowchart of a process for controlling a notification unit executed by a first controller in accordance with the fifth embodiment.

FIG. 12 is a flowchart of a process for controlling a notification unit executed by a first controller in accordance with a first modification.

FIG. 13 is a flowchart of a process for controlling a notification unit executed by a first controller in accordance with a second modification.

FIG. 14 is a block diagram showing the electrical configuration of a human-powered vehicle including a component for the human-powered vehicle in accordance with a third modification.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

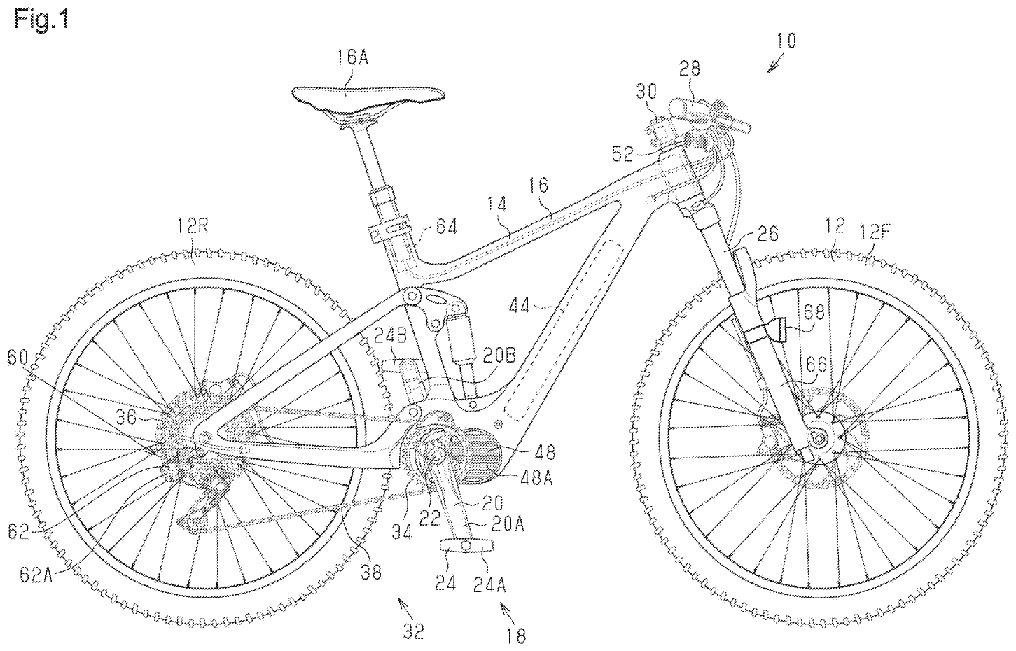

As shown in FIG. 1, a human-powered vehicle 10 is illustrated that is equipped with a component 60 and an electric power supplying system 40. A first embodiment of the component 60 and the electric power supplying system 40 will now be described with reference to FIGS. 1 to 6. The human-powered vehicle 10 is a vehicle including at least one wheel and driven by at least a human driving force. Examples of human-powered vehicles include various types of bicycles such as a mountain bike, a road bike, a city bike, a cargo bike, a hand bike, and a recumbent bike. The number of wheels on the human-powered vehicle is not limited. The human-powered vehicle includes, for example, a unicycle and a vehicle including two or more wheels. The human-powered vehicle is not limited to a vehicle configured to be driven only by a human driving force. The human-powered vehicle includes an E-bike that uses a driving force of an electric motor in addition to a human driving force for propulsion. The E-bike includes an electric assist bicycle that assists in propulsion with an electric motor. In each embodiment described below, the human-powered vehicle 10 will be described as a bicycle.

As shown in FIG. 1, the human-powered vehicle 10 includes at least one wheel 12 and a vehicle body 14. The at least one wheel 12 includes, for example, a front wheel 12F and a rear wheel 12R. The vehicle body 14 includes a frame 16. In an example, a saddle 16A is coupled to the frame 16.

In an example, the human-powered vehicle 10 further includes a crank 18 into which human driving force is input. The crank 18 includes, for example, a crank arm 20 and a crank axle 22. The crank axle 22 is, for example, rotatable relative to the frame 16. In an example, a pedal 24 is coupled to the crank arm 20. The crank arm 20 includes, for example, a first crank arm 20A and a second crank arm 20B. In an example, the pedal 24 includes a first pedal 24A and a second pedal 24B.

The first crank arm 20A and the second crank arm 20B are, for example, provided on respective axial ends of the crank axle 22. In an example, the first pedal 24A is coupled to the first crank arm 20A. In an example, the second pedal 24B is coupled to the second crank arm 20B.

A front fork 26 is joined to the frame 16. The front wheel 12F is attached to the front fork 26. A handlebar 28 is coupled to the front fork 26 by a stem 30. The rear wheel 12R is supported by the frame 16. In the present embodiment, the rear wheel 12R is coupled to the crank 18 by a drive mechanism 32. The rear wheel 12R is driven in accordance with rotation of the crank axle 22. Any one of the front wheel 12F and the rear wheel 12R can be coupled to the crank 18 by the drive mechanism 32.

The drive mechanism 32 includes at least one first rotational body 34 coupled to the crank axle 22. In an example, the at least one first rotational body 34 includes a front sprocket. The at least one first rotational body 34 can include a pulley or a bevel gear. The crank axle 22 can be coupled to the front sprocket by a one-way clutch.

The drive mechanism 32 further includes at least one second rotational body 36 and a transmission member 38. The transmission member 38 is configured to transmit rotational force of the at least one first rotational body 34 to the at least one second rotational body 36. In an example, the transmission member 38 includes a chain. The transmission member 38 can include a belt or a shaft. In an example, the at least one second rotational body 36 includes a rear sprocket. The at least one second rotational body 36 can include a pulley or a bevel gear. In an example, the chain runs on the front sprocket and the rear sprocket. In an example, the at least one second rotational body 36 is coupled to the rear wheel 12R. In an example, the rear wheel 12R is configured to rotate in accordance with rotation of the at least one second rotational body 36.

In an example, the electric power supplying system 40 for a human-powered vehicle includes the component 60 and a relay device 46. In an example, the electric power supplying system 40 for a human-powered vehicle includes the component 60, a first battery 42 and a second battery 44. The second battery 44 differs from the first battery 42.

The component 60 is, for example, a transmission device 62, an electric adjustable seatpost 64, an electric suspension 66, or a lamp 68. In the present embodiment, the component 60 is the transmission device 62.

The transmission device 62 includes, for example, a rear derailleur 62A. The rear derailleur 62A is, for example, provided in a transmission path of a human driving force in the human-powered vehicle 10 and is configured to change a transmission ratio. The transmission ratio is, for example, a ratio of the rotational speed of the at least one wheel 12 to the rotational speed of the crank axle 22. The rotational speed of the at least one wheel 12 includes, for example, the rotational speed of a driving wheel. The drive wheel includes, for example, the rear wheel 12R. The drive wheel can include the front wheel 12F.

The rear derailleur 62A includes, for example, an electric actuator. The electric actuator includes, for example, an electric motor. The electric actuator is, for example, configured to actuate the rear derailleur 62A. The transmission device 62 further includes, for example, the at least one second rotational body 36 and the transmission member 38. The at least one second rotational body 36 includes multiple second rotational bodies 36. The rear derailleur 62A moves the transmission member 38 from one of the second rotational bodies 36 to another one of the second rotational bodies 36 to change the transmission ratio. The relationship of the transmission ratio, the rotational speed of the at least one wheel 12, and the rotational speed of the crank axle 22 is expressed by Equation 1, which is set forth below. In Equation 1, the term R represents the transmission ratio. In Equation 1, the term W represents the rotational speed of the driving wheel. In Equation 1, the term C represents the rotational speed of the crank axle 22.

R=W (rpm)/C (rpm) Equation 1:

The electric adjustable seatpost 64 includes, for example, an electric actuator. The electric actuator includes an electric motor. The electric actuator can include a solenoid instead of the electric motor. The electric adjustable seatpost 64 is, for example, provided on a seat tube. The electric adjustable seatpost 64 is, for example, configured to change the height of the saddle 16A. The electric adjustable seatpost 64 raises and lowers a seatpost relative to the frame 16 to change the height of the saddle 16A.

The electric adjustable seatpost 64 includes, for example, an electrical seatpost or a mechanical seatpost. The electrical seatpost is, for example, configured to extend and retract using the electric actuator. The mechanical seatpost includes a pneumatic seatpost or a hydraulic seatpost. The mechanical seatpost is, for example, configured to control a valve with the force of the electric actuator so that the seatpost is extended by at least one of spring force, pneumatic force, and hydraulic force and retracted by human force.

The electric suspension 66 is configured to absorb impacts applied to the at least one wheel 12. The electric suspension 66 includes, for example, an electric actuator. The electric actuator is, for example, configured to actuate the electric suspension 66. The electric actuator includes an electric motor. The electric actuator can include a solenoid instead of the electric motor. The electric suspension 66 can be a coil suspension, a hydraulic suspension, or an air suspension.

The lamp 68 includes, for example, a front lamp. The front lamp is, for example, attached to the front fork 26. The lamp 68 can include, for example, a tail lamp instead of or in addition to the front lamp. The tail lamp is, for example, attached to a seatstay of the human-powered vehicle 10.

The electric power supplying system 40 can further include a drive unit 48. The drive unit 48 is, for example, configured to apply propulsion force to the human-powered vehicle 10. The drive unit 48 includes, for example, a motor 48A. The drive unit 48 further includes, for example, a housing on which the motor 48A is provided. The drive unit 48 is, for example, provided on the crank axle 22. The drive unit 48 can be a hub motor provided on the at least one wheel 12.

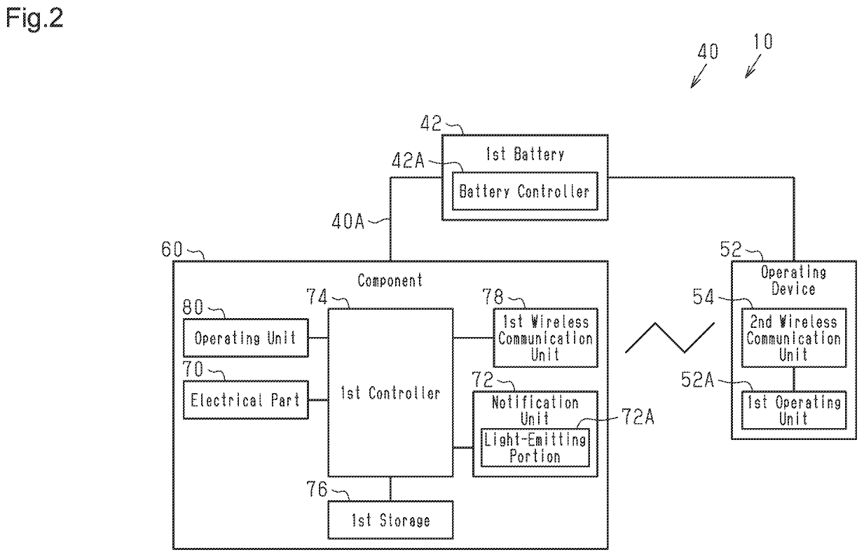

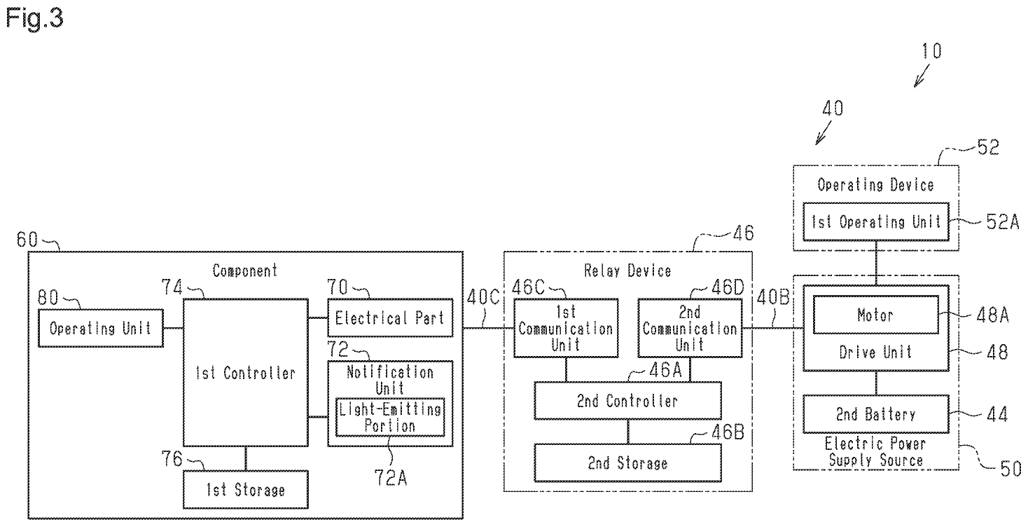

As seen in FIGS. 2 and 3, the component 60 basically includes an electrical part 70, a notification unit 72 and a first controller 74. The electrical part 70 is configured to be supplied with electric power from at least one of the first battery 42 and an electric power supply source 50. In a case where the component 60 is the transmission device 62, the electrical part 70 includes, for example, an electric actuator configured to actuate the rear derailleur 62A. In a case where the component 60 is the electric adjustable seatpost 64, the electrical part 70 includes, for example, an electric actuator configured to extend and retract the seatpost. In a case where the component 60 is the electric suspension 66, the electrical part 70 includes, for example, an electric actuator configured to actuate the electric suspension 66. In a case where the component 60 is the lamp 68, the electrical part 70 includes, for example, a luminous part of the lamp 68.

The first controller 74 includes, for example, a processor that executes a predetermined control program. The processor includes, for example, a central processing unit (CPU) or a micro processing unit (MPU). The first controller 74 can include one or more microcomputers. Thus, the first controller 74 is formed of one or more semiconductor chips that are mounted on a circuit board. The first controller 74 can include a plurality of processors arranged at separate locations. The term “controller” as used herein refers to hardware that executes a software program, and does not include a human being. Accordingly, the first controller 74 can be referred to as a first electronic controller or merely as an electronic controller.

The component 60 further includes, for example, a first storage 76. The first storage 76 stores, for example, control programs and information used for various control processes. The first storage 76 includes, for example, at least one of a nonvolatile memory and a volatile memory. The nonvolatile memory includes, for example, at least one of a read-only memory (ROM), an erasable programmable read only memory (EPROM), an electrically erasable programmable read-only memory (EEPROM), and a flash memory. The volatile memory includes, for example, a random access memory (RAM). The first storage 76 is, for example, connected to the first controller 74 through wired or wireless communication. Thus, the first storage 76 can be any computer storage device or any non-transitory computer-readable medium with the sole exception of a transitory, propagating signal. The first storage 76 is, for example, connected to the first controller 74 through wired or wireless communication.

Referring to FIG. 2, the first battery 42 includes, for example, one or more battery elements. The battery element includes, for example, a rechargeable battery. The first battery 42 includes, for example, a battery controller 42A. The battery controller 42A includes, for example, a processor that executes a predetermined control program. In an example, the processor includes a CPU or an MPU. The battery controller 42A can include one or more microcomputers. The battery controller 42A can include a plurality of processors located at separate positions. The battery controller 42A can be referred to as an electronic battery controller or merely as an electronic controller.

The electric power supplying system 40 further includes, for example, a first electrical cable 40A connected to the first battery 42 and the component 60. The first electrical cable 40A includes, for example, a power line that sends electric power from the first battery 42 to the component 60. The first electrical cable 40A is, for example, configured to be detachably coupled to at least one of the first battery 42 and the component 60.

Referring to FIG. 3, the electric power supply source 50 includes the second battery 44. The second battery 44 includes, for example, one or more battery elements. The second battery 44 is, for example, connected to the drive unit 48 through wired or wireless communication. The second battery 44 can be connected to the component 60 through wired or wireless communication. The second battery 44 is, for example, provided on the frame 16. The second battery 44 can be incorporated in the frame 16 or provided on an outer surface of the frame 16. In the present embodiment, an indication device is provided on at least one of the handlebar 28, the stem 30, a top tube of the frame 16, and the second battery 44. The indication device includes, for example, at least one of a light emitting diode, a liquid crystal display panel, an organic electro-luminescence (EL) panel, and a speaker. The indication device is, for example, configured to present second battery information related to a second battery level of the second battery 44. The indication device allows the user to recognize the second battery information.

The electric power supply source 50 further includes, for example, the drive unit 48. The second battery 44 is, for example, configured to supply electric power to the motor 48A. The second battery 44 is, for example, configured to supply electric power to the electrical part 70 via the drive unit 48. The drive unit 48 is, for example, configured to obtain the second battery level of the second battery 44.

The relay device 46 is connected to both of the component 60 and the electric power supply source 50 in a manner allowing for communication. The component 60 is, for example, connected to the electric power supply source 50 by the relay device 46. Electric power is supplied from the electric power supply source 50 via the relay device 46 to the electrical part 70. The relay device 46 is, for example, supplied with electric power from the second battery 44 via the drive unit 48.

In the electric power supplying system 40 of the first embodiment, only one of the first battery 42 and the second battery 44 is configured to supply electric power to the component 60. In a case where the first battery 42 is configured to supply electric power to the component 60, the drive unit 48, the second battery 44, and the relay device 46 can be omitted from the human-powered vehicle 10. In a case where the first battery 42 is configured to supply electric power to the component 60, the drive unit 48 and the second battery 44 can be omitted from the human-powered vehicle 10 while the human-powered vehicle 10 includes the relay device 46.

The relay device 46 is, for example, detachably coupled to the drive unit 48. The electric power supplying system 40 further includes, for example, a second electrical cable 40B connected to the drive unit 48 and the relay device 46. The second electrical cable 40B includes, for example, a power line that sends electric power from the drive unit 48 to the relay device 46. The second electrical cable 40B is, for example, configured to be detachably coupled to at least one of the drive unit 48 and the relay device 46.

The relay device 46 is, for example, detachably coupled to the component 60. The electric power supplying system 40 further includes, for example, a third electrical cable 40C connected to the component 60 and the relay device 46. The third electrical cable 40C includes, for example, a power line that sends electric power from the relay device 46 to the component 60. The third electrical cable 40C is, for example, configured to be detachably coupled to at least one of the component 60 and the relay device 46. The third electrical cable 40C and the first electrical cable 40A are, for example, the same type of cable. In a case where the first electrical cable 40A and the third electrical cable 40C are configured to be detachably coupled to the component 60, the component 60 includes, for example, a cable mount to which the first electrical cable 40A and the third electrical cable 40C are coupled. Coupling of the first electrical cable 40A to the cable mount allows the first battery 42 to supply electric power to the component 60. Coupling of the third electrical cable 40C to the cable mount allows the second battery 44 to supply electric power to the component 60.

The relay device 46 includes a second controller 46A. The second controller 46A includes, for example, a processor that executes a predetermined control program. In an example, the processor includes a CPU or an MPU. The second controller 46A can include one or more microcomputers. The second controller 46A can include a plurality of processors arranged at separate locations. The second controller 46A can be referred to as an electronic battery controller or merely as an electronic controller.

The relay device 46 further includes, for example, a second storage 46B. The second storage 46B stores, for example, control programs and information used for various control processes. The second storage 46B includes, for example, at least one of a nonvolatile memory and a volatile memory. The nonvolatile memory includes, for example, at least one of a ROM, an EPROM, an EEPROM, and a flash memory. The volatile memory includes, for example, a RAM. The second storage 46B is, for example, connected to the second controller 46A through wired or wireless communication. Thus, the second storage 46B can be any computer storage device or any non-transitory computer-readable medium with the sole exception of a transitory, propagating signal.

The relay device 46 device includes, for example, a first communication unit 46C that communicates with the component 60 and a second communication unit 46D that communicates with the electric power supply source 50. The term “communication unit” as used herein refers to a hardware device or hardware devices, and does not include a human being. The first communication unit 46C can also be referred to as a first communicator or a first communication device, and the second communication unit 46D can also be referred to as a second communicator or a second communication device. In an example, the first communication unit 46C uses a communication protocol differing from that of the second communication unit 46D. Alternatively, the first communication unit 46C can use the same communication protocol as the second communication unit 46D. In an example, the communication protocol of the first communication unit 46C can be the same as that used between the first battery 42 and the component 60. Alternatively, the first communication unit 46C can use a communication protocol differing from that used between the first battery 42 and the component 60.

The first communication unit 46C communicates with the component 60 using, for example, a first communication protocol that is used in the first communication unit 46C. The second communication unit 46D communicates with the drive unit 48 using, for example, a second communication protocol that is used in the second communication unit 46D. The first communication protocol includes, for example, at least one of power line communication (PLC), controller area network (CAN), and universal asynchronous receiver/transmitter (UART). The second communication protocol includes at least one of power line communication, CAN, and UART. In a case where the first communication protocol includes power line communication, sending of electric power from the relay device 46 to the component 60 and communication between the relay device 46 and the component 60 can be performed through a single power line. In a case where the second communication protocol includes power line communication, sending of electric power from the drive unit 48 to the relay device 46 and communication between the relay device 46 and the drive unit 48 can be performed through a single power line.

The first communication unit 46C can be configured to perform wireless communication with the first battery 42. In such as a case, the first communication unit 46C can be referred to as a first wireless communicator or a first wireless communication device. The second communication unit 46D can be configured to perform wireless communication with the drive unit 48. In such as a case, the second communication unit 46D can be referred to as a second wireless communicator or a second wireless communication device.

In an example, the first communication unit 46C is configured to communicate with the component 60 through power line communication, the second communication unit 46D is configured to communicate with the drive unit 48 through CAN or UART, and the first battery 42 is configured to communicate with the component 60 through power line communication. In this case, the first communication unit 46C can be referred to as a first wired communicator or a first wired communication device, and the second communication unit 46D can be referred to as a second wired communicator or a second wired communication device.

The second controller 46A is configured to control at least one of the first communication unit 46C and the second communication unit 46D based on information received from the first communication unit 46C. In an example, in a case where a signal for requesting various types of information from the drive unit 48 is input to the first communication unit 46C, the second controller 46A is configured to control the second communication unit 46D to send a signal for requesting various types of information from the drive unit 48. In an example, in a case where a signal for requesting various types of information from the drive unit 48 is input to the second communication unit 46D, the second controller 46A is configured to control the second communication unit 46D to send a signal for requesting various types of information from the drive unit 48.

The electric power supplying system 40 for a human-powered vehicle further includes, for example, an operating device 52 that operates the component 60. The operating device 52, for example, sends an operation signal for operating the component 60 to the component 60. The operating device 52, for example, sends an operation signal for operating the component 60 to the component 60 via the electric power supply source 50. The first controller 74 is, for example, configured to control the component 60 in accordance with an operation performed on the operating device 52. The operating device 52 is, for example, provided on the handlebar 28. The operating device 52 includes a first operating unit 52A. The first operating unit 52A includes, for example, at least one of a lever, a switch, and a dial. Thus, the first operating unit 52A can be referred to as a first user operating device.

The operating device 52 is connected to the component 60 through wired or wireless communication. In a case where the operating device 52 is connected to the component 60 through wireless communication, the component 60 further includes, for example, a first wireless communication unit 78. In such as a case, the first wireless communication unit 78 can be referred to as a first wireless communicator or a first wireless communication device. In a case where the operating device 52 is connected to the component 60 through wireless communication, the operating device 52 further includes a second wireless communication unit 54. In such as a case, the second wireless communication unit 54 can be referred to as a second wireless communicator or a second wireless communication device. The second wireless communication unit 54 is, for example, configured to perform wireless communication with the first wireless communication unit 78. In a case where the operating device 52 is connected to the component 60 through wired communication, the operating device 52 is configured to communicate with the component 60 through, for example, power line communication, CAN, or UART.

In a case where the electric power supplying system 40 includes the first battery 42, the operating device 52 is, for example, supplied with electric power from the first battery 42. In a case where the electric power supplying system 40 includes the first battery 42, the operating device 52 can be supplied with electric power from a battery that differs from the first battery 42. In a case where the electric power supplying system 40 includes the second battery 44, the operating device 52 is, for example, supplied with electric power from the second battery 44. In a case where the electric power supplying system 40 includes the second battery 44, the operating device 52 can be supplied with electric power from a battery that differs from the second battery 44.

The electric power supplying system 40 is, for example, configured to issue a notification of battery information in accordance with a source that supplies electric power. In an example, in a case where the component 60 receives battery information related to a battery level, the electric power supplying system 40 is configured to issue a notification of the battery information. The battery information includes, for example, at least one of first battery information and second battery information. The first battery information is related to a first battery level of the first battery 42. The second battery information is related to a second battery level of the second battery 44. In the present embodiment, the second battery 44 has a larger capacity than the first battery 42.

The notification unit 72 is, for example, connected to the first controller 74 through wired or wireless communication. The terms “notification unit” and “notification device” as used herein refer to a device or devices, and does not include a human being. The notification unit 72 can also be referred to as a notification device. The notification unit 72 includes, for example, a light-emitting portion 72A. The light-emitting portion 72A includes, for example, a light-emitting diode. The notification unit 72 can include a display instead of or in addition to the light-emitting portion 72A. The display device includes, for example, a liquid crystal display. The display device can include a segment display or an organic electroluminescent (EL) display. The notification unit 72 can include a speaker instead of or in addition to the light-emitting portion 72A.

The first controller 74 is configured to control the notification unit 72. The first controller 74 is, for example, configured to control the notification unit 72 in accordance with the battery information. The first controller 74 is, for example, configured to control the notification unit 72 in accordance with the battery level. The light-emitting portion 72A is, for example, configured to issue a notification of the battery information by changing the amount of light emitted from the light-emitting portion 72A. The light-emitting portion 72A can be configured to issue a notification of the battery information by changing the color of the light-emitting portion 72A. In a case where the notification unit 72 includes a display, the display is, for example, configured to issue a notification of the battery information using image information related to the battery information. The image information includes, for example, at least one of a graph, a numerical value, a gauge, text, and light. In a case where the notification unit 72 includes a speaker, the speaker is, for example, configured to issue a notification of the battery information using sound information related to the battery information. The sound information includes, for example, a voice, a melody, or a beep.

The first controller 74 is configured to control the notification unit 72 and issue a notification of the first battery information in the case where the electrical part 70 is supplied with electric power from the first battery 42 and the electrical part 70 is not supplied with electric power from the electric power supply source 50. The first controller 74 is configured to control the notification unit 72 and restrict notification of the first battery information and the second battery information in a case where the electrical part 70 is supplied with electric power from the electric power supply source 50.

In an example, in a case where a notification request for battery information is issued, the first controller 74 transmits a request for the battery information to an external device of the component 60. In a case where the electric power supplying system 40 includes the first battery 42, the external device is, for example, the first battery 42. In a case where the electric power supplying system 40 includes the second battery 44, the external device is, for example, the relay device 46. In a case where the electric power supplying system 40 includes the second battery 44, the external device can be the drive unit 48.

The component 60 further includes, for example, an operating unit 80 configured to be operable by a user. The operating unit 80 includes, for example, a button. The operating unit 80 can include at least one of a dial and an optical sensor instead of or in addition to the button. Thus, the operating unit 80 can be referred to as a user operating device. The notification request for battery information is generated in a case where a predetermined operation is performed on the operating unit 80. In a case where a predetermined operation is performed on the operating unit 80, the first controller 74, for example, sends a request for battery information to the external device of the component 60. The predetermined operation includes, for example, a first operation in which the operating unit 80 is operated over a predetermined time and a second operation in which the operating unit 80 is operated a number of times. The first operation is, for example, a long press.

In an example, in a case where an operation differing from the predetermined operation is performed on the operating unit 80, the first controller 74 can be configured to perform control other than the request for battery information. In a case where the predetermined operation includes one of the first operation and the second operation, the operation differing from the predetermined operation can include the other of the first operation and the second operation. In an example, in a case where the operation differing from the predetermined operation is performed on the operating unit 80, the first controller 74 sends information other than the request for battery information to an external device.

The first controller 74 is, for example, configured to control the notification unit 72 and issue a notification of the first battery information in a case where the electrical part 70 is not supplied with electric power from the electric power supply source 50 and the predetermined operation is performed on the operating unit 80 in a state in which the electrical part 70 is supplied with electric power from the first battery 42. The first controller 74 is, for example, configured to control the notification unit 72 so as not to issue a notification of the first battery information and the second battery information in a case where the predetermined operation is performed on the operating unit 80 in a state in which the electrical part 70 is supplied with electric power from the electric power supply source 50.

Upon receipt of information from the first controller 74, the battery controller 42A is, for example, configured to execute control in accordance with the information received from the first controller 74. In an example, in a case where the information received from the first controller 74 includes a request for battery information, the battery controller 42A is configured to send the first battery information to the first controller 74.

Upon receipt of information from the first controller 74, the second controller 46A is, for example, configured to execute control in accordance with the information received from the first controller 74. The second controller 46A is, for example, configured to control the first controller 74 and restrict notification of the first battery information and the second battery information. In a case where the first controller 74 restricts notification of the first battery information and the second battery information, the first controller 74, for example, prohibits the notification unit 72 from issuing a notification, or reduces the light of the notification unit 72, or extends the interval of lighting of the notification unit 72, or reduces sound produced by the notification unit 72, or extends the interval of sound produced by the notification unit 72.

In an example, in a case where the information received from the first controller 74 includes a request for battery information, the second controller 46A is configured to ignore the request for battery information. In a case where the second controller 46A ignores the request for battery information, the second battery information is not sent to the first controller 74. The first controller 74 prohibits the notification unit 72 from issuing a notification of battery information in a case where battery information that includes the first battery information and the second battery information is not received. In the present embodiment, the electric power supplying system 40 includes only one of the first battery 42 and the second battery 44. In a case where the electric power supplying system 40 includes only the second battery 44, the notification of battery information is restricted. The second controller 46A is configured to ignore a request for battery information so that the first controller 74 is controlled to restrict notification of the first battery information and the second battery information.

The first controller 74 can be, for example, configured to control the notification unit 72 and restrict notification of the first battery information and the second battery information in a case where the electrical part 70 is supplied with electric power from the electric power supply source 50 regardless of whether the electrical part 70 is supplied with electric power from the first battery 42. In an example, in a case where the second controller 46A receives information including a request for battery information from the first controller 74, the second controller 46A can be configured to obtain second battery information from the drive unit 48 and send the second battery information to the first controller 74. In a case where the first controller 74 receives the second battery information from the second controller 46A, the first controller 74 can be configured to restrict notification of the first battery information and the second battery information. In an example, the second controller 46A can send a signal for restricting notification of the first battery information and the second battery information together with the second battery information to the first controller 74.

In an example, in a case where the first battery information is received from the first battery 42, the first controller 74 is configured to control the notification unit 72 and issue a notification of the first battery information. In an example, in a case where the second battery information is received from the electric power supply source 50, the first controller 74 is configured to control the notification unit 72 and issue a notification of the second battery information. However, in the present embodiment, since the second battery information is not received from the electric power supply source 50, a notification of the first battery information and the second battery information is restricted.

In the present embodiment, the notification unit 72 issues a notification of the first battery information, for example, in a case where the electrical part 70 is not supplied with electric power from the electric power supply source 50, the predetermined operation is performed on the operating unit 80, and the first battery information is obtained from the first battery 42 in a state where the electrical part 70 is supplied with electric power from the first battery 42. In the present embodiment, the notification unit 72 does not issue notification of any battery information in a case where the electrical part 70 is not supplied with electric power from the first battery 42 and the predetermined operation is performed on the operating unit 80 in a state where the electrical part 70 is supplied with electric power from the electric power supply source 50.

The first controller 74 can be configured to control the notification unit 72 and issue a notification of the first battery information in a case where the electrical part 70 is not supplied with electric power from the electric power supply source 50 and the first battery level is less than a predetermined threshold value in a state in which the electrical part 70 is supplied with electric power from the first battery 42. The predetermined threshold value is, for example, stored in the first storage 76. The predetermined threshold value corresponds to, for example, a battery level at which the component 60 is inoperable. The predetermined threshold value is, for example, a value greater than 0 V and close to the minimum operation voltage of the component 60. The minimum operation voltage is, for example, the lower limit value of voltage at which the component 60 functions normally.

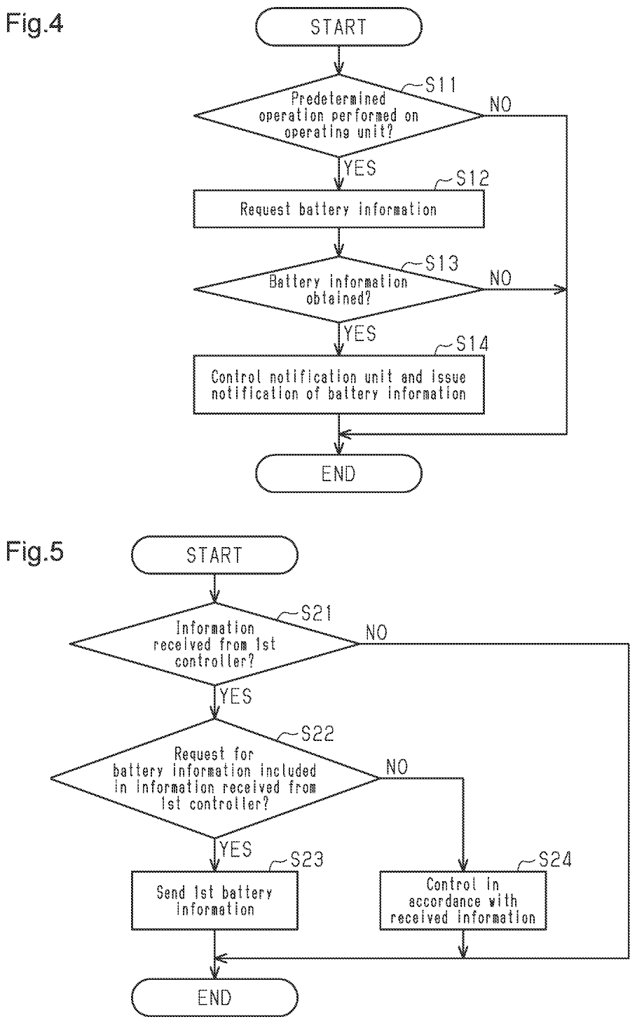

A process for controlling the notification unit 72 with the first controller 74 will now be described with reference to FIG. 4. For example, in a case where electric power is supplied to the first controller 74, the first controller 74 starts the process and proceeds to step S11 of the flowchart shown in FIG. 4. In a case where the flowchart shown in FIG. 4 ends, the first controller 74 repeats the process from step S11 after a predetermined interval, for example, until the supply of electric power stops.

In step S11, the first controller 74 determines whether the predetermined operation is performed on the operating unit 80. In a case where the predetermined operation is not performed on the operating unit 80, the first controller 74 ends the process. In a case where the predetermined operation is performed on the operating unit 80, the first controller 74 proceeds to step S12. In step S12, the first controller 74 requests battery information and proceeds to step S13. In step S12, the first controller 74, for example, sends a request for battery information without specifying the battery. In a case where the electric power supplying system 40 includes the first battery 42, the first battery 42 receives the request for battery information. In a case where the electric power supplying system 40 includes the second battery 44, the second battery 44 receives the request for battery information.

In step S13, the first controller 74 determines whether battery information is obtained. In a case where battery information is not obtained, the first controller 74 end the process. In a case where battery information is obtained, the first controller 74 proceeds to step S14. In an example, in a case where one of the first battery information and the second battery information is obtained, the first controller 74 determines that the battery information is obtained. In step S14, the first controller 74 controls the notification unit 72 and issues a notification of the battery information and then ends the process.

A process executed by the battery controller 42A will now be descried with reference to FIG. 5. In a case where electric power is supplied to, for example, the battery controller 42A, the battery controller 42A starts the process and proceeds to step S21 of the flowchart shown in FIG. 5. In a case where the flowchart shown in FIG. 5 ends, the battery controller 42A repeats the process from step S21 after a predetermined interval, for example, until the supply of electric power stops.

In step S21, the battery controller 42A determines whether information is received from the first controller 74. In a case where information is not received from the first controller 74, the battery controller 42A ends the process. In a case where information is received from the first controller 74, the battery controller 42A proceeds to step S22. In step S22, the battery controller 42A determines whether the information received from the first controller 74 includes a request for battery information. In a case where the information received from the first controller 74 includes a request for battery information, the battery controller 42A proceeds to step S23.

In step S23, the battery controller 42A sends the first battery information and then ends the process. In step S22, in a case where the information received from the first controller 74 does not include a request for battery information, the battery controller 42A proceeds to step S24. In step S24, the battery controller 42A executes control in accordance with the received information and then ends the process. In an example, in a case where the information received from the first controller 74 includes a request to change the control state of the first battery 42, the battery controller 42A changes the control state of the first battery 42 in accordance with the received information. In a case where the information received from the first controller 74 is unrelated to the first battery 42, the battery controller 42A can ignore the information received from the first controller 74.

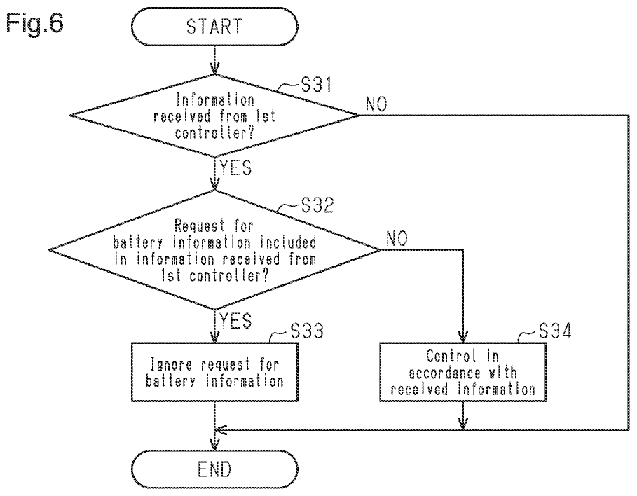

A process executed by the second controller 46A will now be described with reference to FIG. 6. In a case where electric power is supplied to, for example, the second controller 46A, the second controller 46A starts the process and proceeds to step S31 of the flowchart shown in FIG. 6. In a case where the flowchart shown in FIG. 6 ends, the second controller 46A repeats the process from step S31 after a predetermined interval, for example, until the supply of electric power stops.

In step S31, the second controller 46A determines whether information is received from the first controller 74. In a case where information is not received from the first controller 74, the second controller 46A ends the process. In a case where information is received from the first controller 74, the second controller 46A proceeds to step S32. In step S32, the second controller 46A determines whether the information received from the first controller 74 includes a request for battery information. In a case where the information received from the first controller 74 includes a request for battery information, the battery controller 42A proceeds to step S33.

In step S33, the second controller 46A ignores the request for battery information and ends the process. In step S32, in a case where the information received from the first controller 74 does not include a request for battery information, the second controller 46A proceeds to step S34. In step S34, the second controller 46A executes control in accordance with the received information and then ends the process. In a case where the information received from the first controller 74 includes, for example, a request for sending information related to the component 60 to the drive unit 48, the second controller 46A sends the information related to the component 60 to the drive unit 48. In a case where the information received from the first controller 74 includes, for example, a request related to the relay device 46, the second controller 46A controls the relay device 46 in accordance with the received information. In a case where the information received from the first controller 74 is unrelated to the relay device 46 and the electric power supply source 50, the second controller 46A can ignore the information received from the first controller 74.

In the present embodiment, the second battery information is presented by the indication device provided on at least one of the handlebar 28, the stem 30, the top tube of the frame 16, and the second battery 44. In a case where the electrical part 70 is supplied with electric power from the electric power supply source 50, the first controller 74 prohibits the notification unit 72 from issuing a notification of the battery level. This reduce consumption of electric power and avoids confusion of the user caused by a difference in the presented information between the indication device and the notification unit 72.

### Second Embodiment

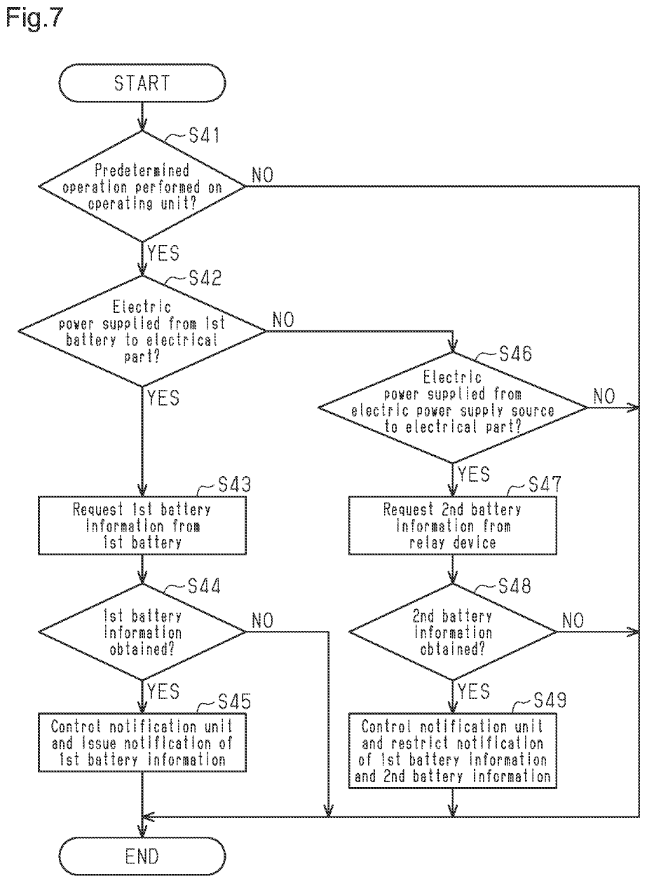

A second embodiment of the component 60 for the human-powered vehicle 10 will now be described with reference to FIG. 7. In the component 60 for the human-powered vehicle 10 of the second embodiment, same reference characters are given to those elements that are the same as the corresponding elements in the first embodiment. Such elements will not be described in detail.

In the second embodiment, the first controller 74 is configured to determine whether or not the electrical part 70 is supplied with electric power from each of the first battery 42 and the electric power supply source 50 and issue a request for the first battery information or the second battery information in accordance with the determination result.

In an example, in a case where the electrical part 70 is supplied with electric power from the first battery 42, the first controller 74 is configured to control the notification unit 72 and issues a notification of the first battery information. In a case where the electrical part 70 is not supplied with electric power from the first battery 42 and is supplied with electric power from the electric power supply source 50, the first controller 74 is configured to control the notification unit 72 and restrict notification of the first battery information and the second battery information.

In the second embodiment, the component 60 can be configured to supply electric power to the electrical part 70 from both the first battery 42 and the electric power supply source 50. In the second embodiment, the component 60 can be configured to supply electric power to the electrical part 70 from only one of the first battery 42 and the electric power supply source 50.

In the second embodiment, for example, the first controller 74 is configured to determine whether the electrical part 70 is supplied with electric power from the first battery 42 and determine whether the electrical part 70 is supplied with electric power from the electric power supply source 50. In an example, the first controller 74 obtains identification information of the first battery 42 to determine whether the electrical part 70 is supplied with electric power from the first battery 42. In an example, the first controller 74 obtains identification information of the relay device 46 to determine whether the electrical part 70 is supplied with electric power from the electric power supply source 50. Alternatively, the first controller 74 can be configured to obtain identification information of the drive unit 48 or the second battery 44 and determine whether the electrical part 70 is supplied with electric power from the second battery 44.

The first controller 74 can be configured to determine whether the electrical part 70 is supplied with electric power from the first battery 42 by detecting the state of connection to the first battery 42. The first controller 74 can be configured to determine whether the electrical part 70 is supplied with electric power from the electric power supply source 50 by detecting the state of connection to the relay device 46 or the electric power supply source 50.

A process for controlling the notification unit 72 with the first controller 74 of the second embodiment will now be described with reference to FIG. 7. For example, in a case where electric power is supplied to the first controller 74, the first controller 74 starts the process and proceeds to step S41 of the flowchart shown in FIG. 7. In a case where the flowchart shown in FIG. 7 ends, the first controller 74 repeats the process from step S41 after a predetermined interval, for example, until the supply of electric power stops.

In step S41, the first controller 74 determines whether the predetermined operation is performed on the operating unit 80. In a case where the predetermined operation is performed on the operating unit 80, the first controller 74 proceeds to step S42. In a case where the predetermined operation is not performed on the operating unit 80, the first controller 74 ends the process. In step S42, the first controller 74 determines whether the electrical part 70 is supplied with electric power from the first battery 42. In a case where the electrical part 70 is supplied with electric power from the first battery 42, the first controller 74 proceeds to step S43.

In step S43, the first controller 74 requests the first battery information from the first battery 42 and proceeds to step S44. In step S44, the first controller 74 determines whether the first battery information is obtained. In a case where the first battery information is not obtained, the first controller 74 end the process. In a case where the first battery information is obtained, the first controller 74 proceeds to step S45. In step S45, the first controller 74 controls the notification unit 72 and issues a notification of the first battery information and then ends the process.

In step S42, in a case where the electrical part 70 is not supplied with electric power from the first battery 42, the first controller 74 proceeds to step S46. In step S46, the first controller 74 determines whether the electrical part 70 is supplied with electric power from the electric power supply source 50. In a case where the electrical part 70 is not supplied with electric power from the electric power supply source 50, the first controller 74 ends the process. In a case where the electrical part 70 is supplied with electric power from the electric power supply source 50, the first controller 74 proceeds to step S47.

In step S47, the first controller 74 requests the second battery information from the relay device 46 and proceeds to step S48. In step S48, the first controller 74 determines whether the second battery information is obtained. In a case where the second battery information is not obtained, the first controller 74 end the process. In a case where the second battery information is obtained, the first controller 74 proceeds to step S49. In step S49, the first controller 74 controls the notification unit 72 to restrict notification of the first battery information and the second battery information and then ends the process.

In the second embodiment, in a case where the component 60 is configured to supply electric power to the electrical part 70 from both the first battery 42 and the electric power supply source 50, in step S45, the first controller 74 can be configured to control the notification unit 72 so that a notification of the first battery information and a notification of the second battery information are alternately issued or so that a notification of the sum of the first battery level and the second battery level is issued.

In a case where the electrical part 70 is supplied with electric power from the first battery 42, the first controller 74 of the second embodiment controls the notification unit 72 so that the notification unit 72 issues a notification of the first battery level. This allows the user to recognize the first battery level. In a case where the component 60 is configured to supply electric power to the electrical part 70 from only one of the first battery 42 and the electric power supply source 50 and the electrical part 70 is supplied with electric power from the first battery 42, the user recognizes the first battery level. In a case where the component 60 is configured to supply electric power to the electrical part 70 from only one of the first battery 42 and the electric power supply source 50 and the electrical part 70 is supplied with electric power from the second battery 44, notification of the second battery level is restricted.

### Third Embodiment

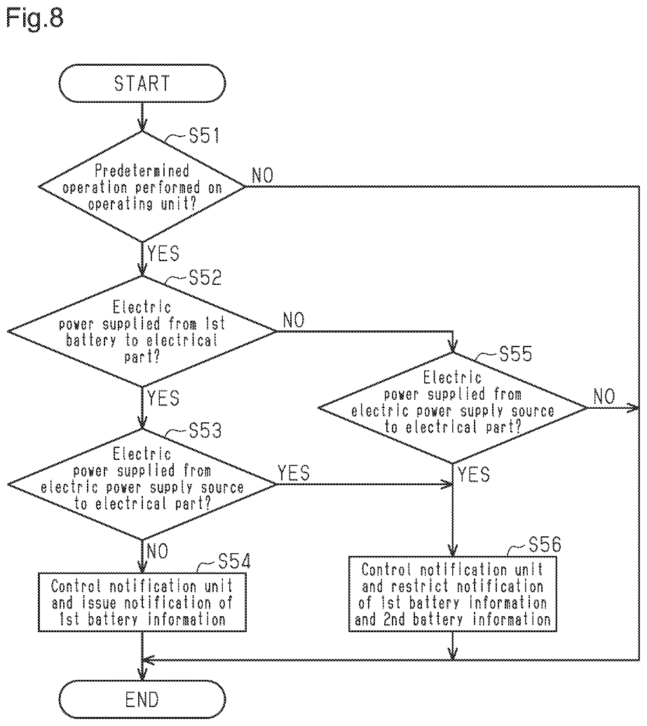

A third embodiment of the component 60 for the human-powered vehicle 10 will now be described with reference to FIG. 8. The component 60 for the human-powered vehicle 10 of the third embodiment has the same configuration as the first embodiment except for restriction of notification of battery information in a case where the electrical part 70 is supplied with electric power from the electric power supply source 50 regardless of whether the electrical part 70 is supplied with electric power from the first battery 42. In the component 60 for the human-powered vehicle 10 of the third embodiment, same reference characters are given to those elements that are the same as the corresponding elements in the first embodiment. Such elements will not be described in detail.

In the third embodiment, the first controller 74 is configured to control the notification unit 72 and issue a notification of battery information in accordance with determination of whether or not the electrical part 70 is supplied with electric power from each of the first battery 42 and the electric power supply source 50. In the same manner as the second embodiment, in the third embodiment, the first controller 74 can be configured to determine whether or not the electrical part 70 is supplied with electric power from each of the first battery 42 and the electric power supply source 50 and request the first battery information and the second battery information in accordance with the determination result. The first controller 74 of the third embodiment can be configured to request the first battery information and the second battery information, determine whether or not the electrical part 70 is supplied with electric power from each of the first battery 42 and the electric power supply source 50, and select information that is issued from the notification unit 72 based on the determination result.

A process for controlling the notification unit 72 with the first controller 74 of the third embodiment will now be described with reference to FIG. 8. For example, in a case where electric power is supplied to the first controller 74, the first controller 74 starts the process and proceeds to step S51 of the flowchart shown in FIG. 8. In a case where the flowchart shown in FIG. 8 ends, the first controller 74 repeats the process from step S51 after a predetermined interval, for example, until the supply of electric power stops.

In step S51, the first controller 74 determines whether the predetermined operation is performed on the operating unit 80. In a case where the predetermined operation is performed on the operating unit 80, the first controller 74 proceeds to step S52. In a case where the predetermined operation is not performed on the operating unit 80, the first controller 74 ends the process. In step S52, the first controller 74 determines whether the electrical part 70 is supplied with electric power from the first battery 42. In a case where the electrical part 70 is supplied with electric power from the first battery 42, the first controller 74 proceeds to step S53.

In step S53, the first controller 74 determines whether the electrical part 70 is supplied with electric power from the electric power supply source 50. In a case where the electrical part 70 is supplied with electric power from the electric power supply source 50, the first controller 74 proceeds to step S56. In a case where the electrical part 70 is not supplied with electric power from the electric power supply source 50, the first controller 74 proceeds to step S54. In step S54, the first controller 74 controls the notification unit 72 and issues a notification of the first battery information and then ends the process.

In step S52, in a case where the electrical part 70 is not supplied with electric power from the first battery 42, the first controller 74 proceeds to step S55. In step S55, the first controller 74 determines whether the electrical part 70 is supplied with electric power from the electric power supply source 50. In a case where the electrical part 70 is not supplied with electric power from the electric power supply source 50, the first controller 74 ends the process. In a case where the electrical part 70 is supplied with electric power from the electric power supply source 50, the first controller 74 proceeds to step S56. In step S56, the first controller 74 controls the notification unit 72 to restrict notification of the first battery information and the second battery information and then ends the process.

### Fourth Embodiment

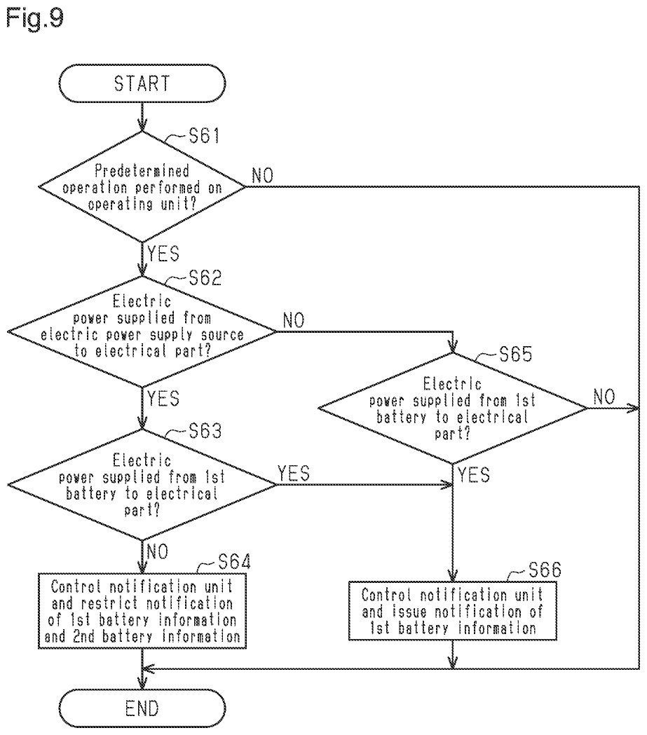

A fourth embodiment of the component 60 for the human-powered vehicle 10 will now be described with reference to FIG. 9. The component 60 for the human-powered vehicle 10 of the fourth embodiment has the same configuration as the third embodiment except that a notification of battery information is issued in a case where the electrical part 70 is supplied with electric power from the first battery 42 regardless of whether the electrical part 70 is supplied with electric power from the electric power supply source 50. In the component 60 for the human-powered vehicle 10, same reference characters are given to those elements that are the same as the corresponding elements in the first embodiment. Such elements will not be described in detail.

A process for controlling the notification unit 72 with the first controller 74 of the fourth embodiment will now be described with reference to FIG. 9. For example, in a case where electric power is supplied to the first controller 74, the first controller 74 starts the process and proceeds to step S61 of the flowchart shown in FIG. 9. In a case where the flowchart shown in FIG. 9 ends, the first controller 74 repeats the process from step S61 after a predetermined interval, for example, until the supply of electric power stops.

In step S61, the first controller 74 determines whether the predetermined operation is performed on the operating unit 80. In a case where the predetermined operation is performed on the operating unit 80, the first controller 74 proceeds to step S62. In a case where the predetermined operation is not performed on the operating unit 80, the first controller 74 ends the process. In step S62, the first controller 74 determines whether the electrical part 70 is supplied with electric power from the electric power supply source 50. In a case where the electrical part 70 is supplied with electric power from the electric power supply source 50, the first controller 74 proceeds to step S63.

In step S63, the first controller 74 determines whether the electrical part 70 is supplied with electric power from the first battery 42. In a case where the electrical part 70 is supplied with electric power from the first battery 42, the first controller 74 proceeds to step S66. In a case where the electrical part 70 is not supplied with electric power from the first battery 42, the first controller 74 proceeds to step S64. In step S64, the first controller 74 controls the notification unit 72 to restrict notification of the first battery information and the second battery information and then ends the process.

In step S62, in a case where the electrical part 70 is not supplied with electric power from the electric power supply source 50, the first controller 74 proceeds to step S65. In step S65, the first controller 74 determines whether the electrical part 70 is supplied with electric power from the first battery 42. In a case where the electrical part 70 is not supplied with electric power from the first battery 42, the first controller 74 ends the process. In a case where the electrical part 70 is supplied with electric power from the first battery 42, the first controller 74 proceeds to step S66. In step S66, the first controller 74 controls the notification unit 72 and issues a notification of the first battery information and then ends the process.

### Fifth Embodiment

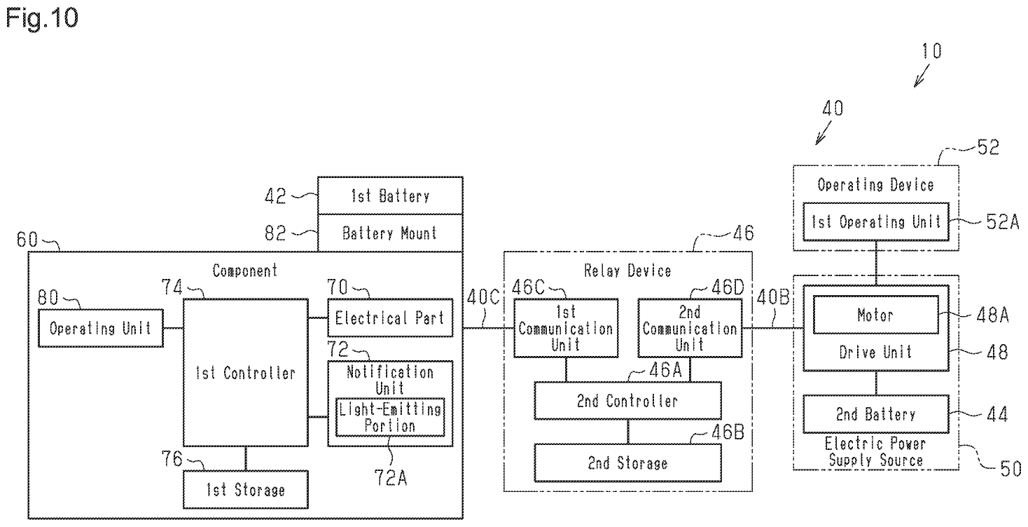

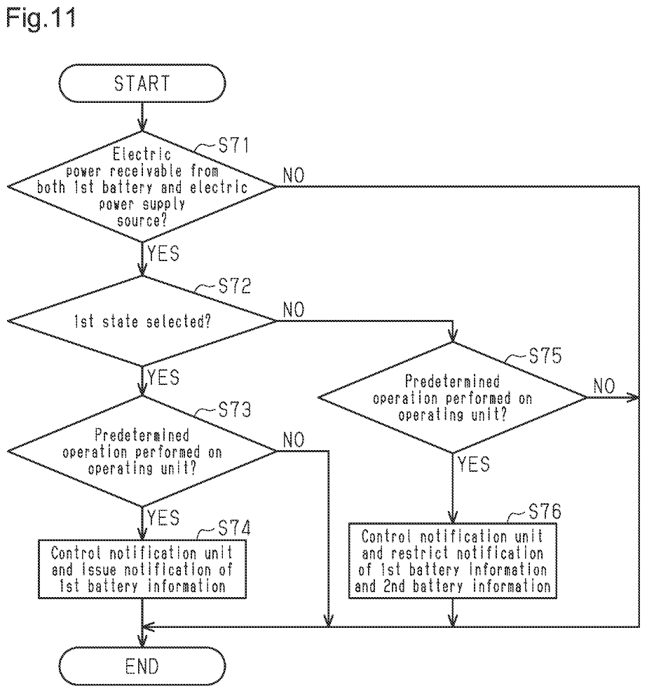

The electric power supplying system 40 for the human-powered vehicle 10 and the component 60 for the human-powered vehicle 10 of the fifth embodiment will now be described with reference to FIGS. 10 and 11. In the electric power supplying system 40 for the human-powered vehicle 10 and the component 60 for the human-powered vehicle 10 of the fifth embodiment, the same reference characters are given to those elements that are the same as the corresponding elements of the first embodiment. Such elements will not be described in detail.

As shown in FIG. 10, in the fifth embodiment, the electric power supplying system 40 for the human-powered vehicle 10 includes, for example, the component 60, a first battery 42, and a second battery 44. In the fifth embodiment, the electric power supplying system 40 includes both the first battery 42 and the second battery 44.

The first battery 42 of the fifth embodiment is, for example, provided on the component 60. The component 60 further includes, for example, a battery mount 82 allowing for attachment and detachment of the first battery 42. The battery mount 82 is, for example, provided on a housing of the component 60. The battery mount 82 can be accommodated in the housing of the component 60 or provided on the outside of the housing. The battery mount 82 includes, for example, a fastener. The fastener includes, for example, a screw.

The first controller 74 of the fifth embodiment can include the battery controller 42A of the first embodiment. The first controller 74 can be, for example, configured to obtain the first battery level from a voltage detection circuit of the first battery 42.

For example, in a case where electric power from both of the first battery 42 and the electric power supply source 50 is receivable by the component 60, the first controller 74 is configured to select either one of a first state and a second state. The first state is a state in which the electrical part 70 is supplied with electric power from the first battery 42 and is not supplied with electric power from the electric power supply source 50. The second state is a state in which the electrical part 70 is not supplied with electric power from the first battery 42 and is supplied with electric power from the electric power supply source 50.

The first state and the second state are configured, for example, to be selected by the user. In an example, the user operates a predetermined operating unit provided on the component 60 and an information processing unit configured to operate the component 60 to select one of the first state and the second state. The information processing unit includes, for example, at least one of a personal computer, a tablet computer, a smartphone, and a cycle computer. The predetermined operating unit can differ from the operating unit 80 or be integrated with the operating unit 80. In a case where the predetermined operating unit is integrated with the operating unit 80, for example, the operation for selecting one of the first state and the second state differs from the predetermined operation for controlling the notification unit 72.

A process for controlling the notification unit 72 with the first controller 74 of the fifth embodiment will now be described with reference to FIG. 11. For example, in a case where electric power is supplied to the first controller 74, the first controller 74 starts the process and proceeds to step S71 of the flowchart shown in FIG. 11. In a case where the flowchart shown in FIG. 11 ends, the first controller 74 repeats the process from step S71 after a predetermined interval, for example, until the supply of electric power stops.

In step S71, the first controller 74 determines whether electric power is receivable from both the first battery 42 and the electric power supply source 50. In a case where electric power is not receivable from the first battery 42 and the electric power supply source 50, the first controller 74 ends the process. In a case where electric power is receivable from both the first battery 42 and the electric power supply source 50, the first controller 74 proceeds to step S72. In step S72, the first controller 74 determines whether the first state is selected. In an example, in a case where the first state is selected by the user, the first controller 74 determines that the first state is selected. In a case where the first state is selected, the first controller 74 proceeds to step S73.

In step S73, the first controller 74 determines whether the predetermined operation is performed on the operating unit 80. In a case where the predetermined operation is performed on the operating unit 80, the first controller 74 proceeds to step S74. In a case where the predetermined operation is not performed on the operating unit 80, the first controller 74 ends the process. In step S74, the first controller 74 controls the notification unit 72 and issues a notification of the first battery information and then ends the process.

In step S72, in a case where the first state is not selected, the first controller 74 proceeds to step S75. In an example, in a case where the second state is selected, the first controller 74 determines that the first state is not selected. In step S75, the first controller 74 determines whether the predetermined operation is performed on the operating unit 80. In a case where the predetermined operation is performed on the operating unit 80, the first controller 74 proceeds to step S76. In a case where the predetermined operation is not performed on the operating unit 80, the first controller 74 ends the process. In step S76, the first controller 74 controls the notification unit 72 to restrict notification of the first battery information and the second battery information and then ends the process.

### Modifications

The description related to the above embodiments exemplifies, without any intention to limit, applicable forms of a component for a human-powered vehicle and an electric power supplying system for a human-powered vehicle according to the present disclosure. The human-powered vehicle component and the human-powered vehicle electric power supplying system according to the present disclosure can be applied to, for example, modifications of the embodiments that are described below and combinations of at least two of the modifications that do not contradict each other. In the modifications described hereafter, same reference characters are given to those elements that are the same as the corresponding elements of the above embodiments. Such elements will not be described in detail.

In the first to third embodiments, the relay device 46 can be omitted from the electric power supplying system 40. In a case where the electric power supplying system 40 does not include the relay device 46, the component 60 is, for example, directly connected to the drive unit 48. In a case where the electric power supplying system 40 does not include the relay device 46, one of the drive unit 48 and the second battery 44 can include the function of the second controller 46A.

In the first to third embodiments, in a case where the indication device for presenting the second battery information is not provided on any of the handlebar 28, the stem 30, the top tube of the frame 16, and the second battery 44 and the electrical part 70 is supplied with electric power from the electric power supply source 50, the first controller 74 can be configured to cause the notification unit 72 to issue a notification of a battery level. In this modification, if the electrical part 70 is not supplied with electric power from the first battery 42 in a case where the electrical part 70 is supplied with electric power from the electric power supply source 50, the notification unit 72 issues a notification of the second battery level. In this modification, in a case where the electrical part 70 is supplied with electric power from both the first battery 42 and the electric power supply source 50, the notification unit 72 can be configured to issue a notification of the second battery level or separately issue notifications of the first battery level and the second battery level.

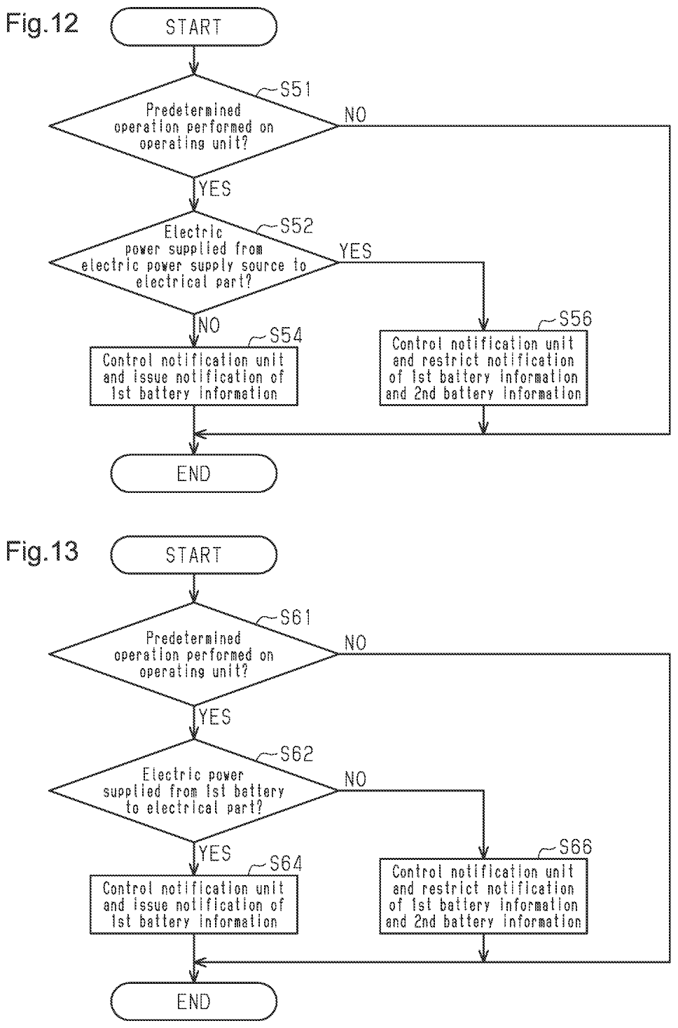

In the third embodiment, the determination of whether the electrical part 70 is supplied with electric power from the first battery 42 does not necessarily have to be performed. For example, in the flowchart shown in FIG. 8, steps S53 and S55 can be omitted. In a first modification in which steps S53 and S55 are omitted from the flowchart shown in FIG. 8, a process for controlling the notification unit 72 with the first controller 74 will now be described with reference to FIG. 12. In step S52, in a case where the electrical part 70 is not supplied with electric power from the electric power supply source 50, the first controller 74 proceeds to step S54. In step S52, in a case where the electrical part 70 is supplied with electric power from the electric power supply source 50, the first controller 74 proceeds to step S56.

In the fourth embodiment, the determination of whether the electrical part 70 is supplied with electric power from the electric power supply source 50 does not necessarily have to be performed. For example, in the flowchart shown in FIG. 9, steps S63 and S65 can be omitted. In a second modification in which steps S63 and S65 are omitted from the flowchart shown in FIG. 9, a process for controlling the notification unit 72 with the first controller 74 will now be described with reference to FIG. 13. In step S62, in a case where the electrical part 70 is supplied with electric power from the first battery 42, the first controller 74 proceeds to step S64. In step S62, in a case where the electrical part 70 is not supplied with electric power from the first battery 42, the first controller 74 proceeds to step S66.

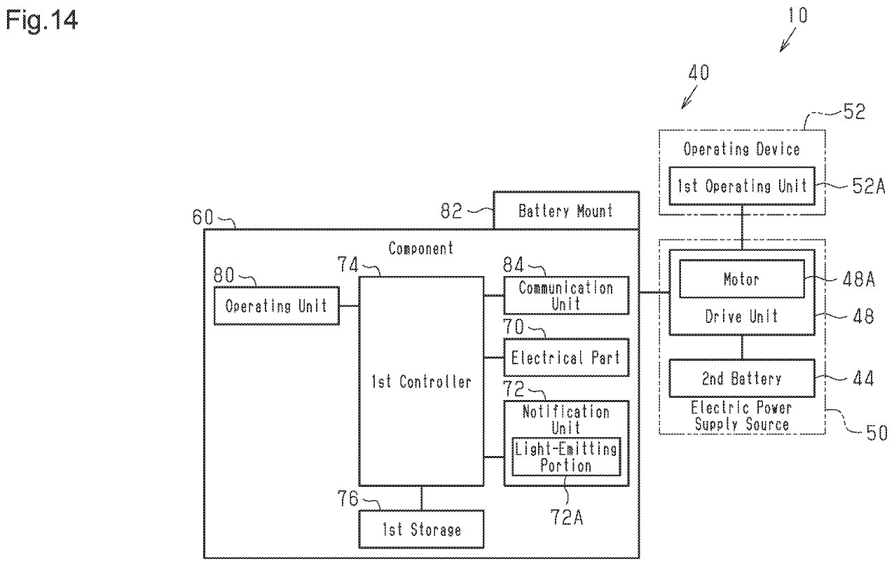

As shown in FIG. 14, the component 60 can further include a communication unit 84 that receives the second battery information. In a case where the component 60 further includes the communication unit 84, the component 60 and the electric power supply source 50 can be connected without using the relay device 46.

The first controller 74 can be configured to control the notification unit 72 so as not to issue a notification of the second battery information in a case where the electrical part 70 is supplied with electric power from the electric power supply source 50 and the component 60 is connected to the electric power supply source 50 through power line communication without using the relay device 46.

The first controller 74 can be configured to control the notification unit 72 so as to issue a notification of the second battery information in a case where the electrical part 70 is supplied with electric power from the electric power supply source 50 and the component 60 is connected to the electric power supply source 50 through power line communication without using the relay device 46.

In this specification, the phrase “at least one of” as used in this disclosure means “one or more” of a desired choice. As one example, the phrase “at least one of” as used in this disclosure means “only one choice” or “both of two choices” in a case where the number of choices is two. In another example, in this specification, the phrase “at least one of” as used in this disclosure means “only one single choice” or “any combination of equal to or more than two choices” if the number of its choices is equal to or more than three.

In this specification, ordinal numbers such as “first, second, and third” are used to merely distinguish between members having the same name and have no particular meaning.

What is claimed is:

1. A component for a human-powered vehicle, the component comprising:
an electrical part configured to be supplied with electric power from at least one of a first battery and an electric power supply source including a second battery that differs from the first battery;
a notification device; and
a first controller configured to control the notification unit and issue a notification of first battery information related to a first battery level of the first battery in a case where the electrical part is supplied with electric power from the first battery and is not supplied with electric power from the electric power supply source; and
the first controller being further configured to control the notification unit and restrict notification of the first battery information and second battery information related to a second battery level of the second battery in a case where the electrical part is supplied with electric power from the electric power supply source.

2. A component for a human-powered vehicle, the component comprising:
an electrical part configured to be supplied with electric power from at least one of a first battery and an electric power supply source including a second battery that differs from the first battery;
a notification device; and
a first controller configured to control the notification device and issue a notification of first battery information related to a first battery level of the first battery in a case where the electrical part is supplied with electric power from the first battery; and
the first controller being further configured to control the notification device and restrict notification of the first battery information and second battery information related to a second battery level of the second battery in a case where the electrical part is supplied with electric power from the electric power supply source and not supplied with electric power from the first battery.

3. The component according to claim 1, further comprising
a user operating device configured to be operable by a user,
the first controller being further configured to control the notification device and issue the notification of the first battery information in a case where the electrical part is not supplied with electric power from the electric power supply source and a predetermined operation is performed on the operating device in a state in which the electrical part is supplied with electric power from the first battery.

4. The component according to claim 3, wherein
the first controller is configured to control the notification device so as not to issue a notification of the first battery information and the second battery information in a case where the predetermined operation is performed on the operating device in a state in which the electrical part is supplied with electric power from the electric power supply source.

5. The component according to claim 4, wherein
the predetermined operation includes a first operation in which the operating device is operated over a predetermined time and a second operation in which the operating device is operated a number of times.

6. The component according to claim 1, wherein
the first controller is configured to control the notification device and issue the notification of the first battery information in a case where the electrical part is not supplied with electric power from the electric power supply source and the first battery level is less than or equal to a predetermined threshold value in a state in which the electrical part is supplied with electric power from the first battery.

7. The component according to claim 1, further comprising
a battery mount allowing for attachment and detachment of the first battery.

8. The component according to claim 1, wherein
the notification device includes a light-emitting portion.

9. The component according to claim 1, further comprising
a communication device that receives the second battery information.

10. The component according to claim 1, wherein
the component is a transmission device, an electric adjustable seatpost, an electric suspension, or a lamp.

11. The component according to claim 10, wherein
the component is the transmission device; and
the transmission device includes a rear derailleur.

12. The component according to claim 1, wherein
in a case where electric power from both of the first battery and the electric power supply source is receivable by the component, the first controller is configured to select either one of a first state, in which the electrical part is supplied with electric power from the first battery and the electrical part is not supplied with electric power from the electric power supply source, and a second state, in which the electrical part is not supplied with electric power from the first battery and the electrical part is supplied with electric power from the electric power supply source.

13. An electric power supplying system for a human-powered vehicle, the electric power supplying system comprising:
the component according to claim 1;
the first battery; and
the second battery.

14. An electric power supplying system for a human-powered vehicle, the electric power supplying system comprising:
the component according to claim 1; and
a relay device connected to both of the component and the electric power supply source in a manner allowing for communication.

15. The electric power supplying system according to claim 14, wherein
the relay device includes a first communication device that communicates with the component and a second communication device that communicates with the electric power supply source; and
the first communication device uses a communication protocol differing from that of the second communication device.

16. The electric power supplying system according to claim 14, wherein
the relay device includes a second controller; and
the second controller is configured to control the first controller and restrict notification of the first battery information and the second battery information.

17. The electric power supplying system according to claim 14, wherein
electric power is supplied from the electric power supply source via the relay device to the electrical part.

18. The electric power supplying system according to claim 14, wherein
the electric power supply source further includes a drive unit configured to apply a propulsion force to the human-powered vehicle; and
the second battery is configured to supply the electrical part with electric power via the drive unit.

19. The electric power supplying system according to claim 14, further comprising:
an operating device used to operate the component,
wherein the operating device sends an operation signal for operating the component via the electric power supply source to the component.
